(19) United States
(12) Patent Application Publication
(10) Pub. No.: US 2013/0048149 A1
(43) Pub. Date: Feb. 28, 2013

(54) Woodworking Machining Apparatus

(71) Applicant: Rong-Cheng Liu, Taichung City (TW)

(72) Inventor: Rong-Cheng Liu, Taichung City (TW)

(21) Appl. No.: 13/217,395

(22) Filed: Aug. 25, 2011

(51) Int. Cl. B27C 7/04

(52) U.S. Cl. 144/278.1

(57) ABSTRACT

A woodworking machining apparatus includes a bed, a machining assembly, a driving mechanism and a clamping mechanism. The clamping mechanism is mounted on the bed and is movable relative to the machining assembly. The clamping mechanism has a height adjuster and a holding adjuster. The height adjuster includes a height adjusting base, a sliding rod, first connecting rod, a second connecting rod, a height adjusting lever and a stabilizing board for stably lifting the holding adjuster. The holding adjuster includes a holding base, two clamping sheets and a holding lever for keeping a wood workpiece in a middle of the holding adjuster. The wood workpiece is clamped between the clamping sheets and is lifted by the height adjuster. Therefore, an axis of the wood workpiece can be aligned with the machining assembly.

### BACKGROUND OF THE INVENTION

1. Field of the Invention

The present invention relates to a machining apparatus, and more particularly to a woodworking machining apparatus.

2. Description of Related Art

A conventional woodworking machining device includes a workbench, a milling tool, a motor and a tailstock. The workbench has a flat top and a groove defined in the flat top and extending along a length of the workbench. The milling tool and the motor are fixed on the flat top. The motor is connected with the milling tool for driving the milling tool. The tailstock is movably mounted on the flat top of the workbench and is mounted over and is slidable relative to the groove in the workbench. The tailstock includes a base, a first plate, a second plate and a screw bolt. The base is slidable relative workbench along the groove. The first plate and the second plate are respectively mounted on the base. The first plate and the second plate are perpendicular to the base. The screw bolt is screwed through the first plate. The screw bolt has a clamping head located between the first plate and the second plate for clamping a wood workpiece positioned between the clamping head and the second plate. When the screw bolt is screwedly moved relative to the second plate, a distance between the clamping head and the second plate is adjustable for fitting various diameters of wood workpieces. When the wood workpiece is machined, the base is slidably moved along the groove to stably feed the wood workpiece into the milling tool.

However, the wood workpiece is clamped between the second plate and the clamping head. The first plate and the second plate can not be moved relative to each other, such that an axis of a wood workpiece of different diameters or sizes can not be positioned in a center line between the plates of the tailstock and be aligned with the milling tool. Therefore, the wood workpiece is not precisely machined. In addition, a height of the tailstock is not adjustable.

To overcome the shortcomings, the present invention tends to provide a woodworking machining apparatus to mitigate or obviate the aforementioned problems.

### SUMMARY OF THE INVENTION

The main objective of the invention is to provide a woodworking machining apparatus includes a bed, a machining assembly, a driving mechanism and a clamping mechanism. The bed has a bed-top disposed on a top of the bed. The bed-top has a ditch defined through the bed-top. The machining assembly is mounted over the ditch in the bed-top. The driving mechanism is mounted on the bed for driving the machining assembly. The clamping mechanism is mounted over the ditch in the bed-top, is movable relative to the ditch and has a height adjuster and a holding adjuster.

The height adjuster includes a height adjusting base, a sliding rod, first connecting rod, a second connecting rod, a height adjusting lever and a stabilizing board. The height adjusting base has a first seat disposed on a top of the height adjusting base, a second seat disposed on the top of the height adjusting base, a protrusion extending from a bottom of the height adjusting base to be correspondingly received in the ditch, and at least two supports disposed on the bottom of the height adjusting base and respectively located on two sides of the protrusion for lifting the height adjusting base from the bed-top. The first seat has a first slot defined through the first seat. The sliding rod is mounted in the first seat, has one end mounted in the first slot, and is slidable along the first slot. The first connecting rod has a first end and a second end being opposite to the first end. The first end of the first connecting rod is pivotally connected to the sliding rod, is pivotable relative to the sliding rod and is pivotally connected to the first seat. The second connecting rod has a first end, a second end being opposite to the first end and a middle part located between the first end and the second end. The first end of the second connecting rod is pivotally connected to the second seat. The middle part of the second connecting rod is pivotally connected to a middle part of the first connecting rod such that the second connecting rod and the first connecting rod are moved related to each other. The height adjusting lever is rotatably mounted on the height adjusting base and screwed through the sliding rod for screwedly driving the sliding rod to move relative to the height adjusting lever. The stabilizing board is fixed on a bottom of the protrusion of the height adjusting base and has a width greater than that of the ditch, such that the bed-top is located between the at least two supporters of the height adjusting base and the stabilizing board.

The holding adjuster is movably mounted on the height adjuster and includes a holding base, two clamping sheets and a holding lever. The holding base has a second slot defined in one side of the holding base and an adjusting groove defined in a top of the holding base. The second end of the first connecting rod is pivotally connected to the holding base. The second end of the second connecting rod is pivotally mounted in the second slot and is movable along the second slot. The two clamping sheets are partially received in the adjusting groove in parallel. Each clamping sheet has a screw hole defined through the clamping sheet. A thread in the screw hole of one of the clamping sheets is opposite to that of the other clamping sheet in thread direction. The holding lever is rotatably mounted on the holding base and screwed through the two screw holes of the two clamping sheets for driving the two clamping sheets to move relative to each other.

Each supporter includes an elastomer mounted in the bottom of the height adjusting base and a ball abutting with on the elastomer and protruding from the bottom of the height adjusting base.

The holding lever has a handle disposed on one end of the holding lever and a fixing ring fixed on the other end of the holding lever to prevent the holding lever from detaching from the holding base. The height adjusting lever has a threaded portion disposed on one end of the height adjusting lever for screwing through the sliding rod, a handle disposed on the other end of the height adjusting lever, and a buckling ring fixed on the height adjusting lever and located between the threaded portion and handle to prevent the height adjusting lever from detaching from the height adjusting base.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a woodworking machining apparatus in accordance with the present invention;

FIG. 2 is an enlarged perspective view of a clamping mechanism of the woodworking machining apparatus in FIG. 1;

FIG. 3 is a side view of the clamping mechanism of the woodworking 1 machining apparatus in FIG. 2;

FIG. 4 is an enlarged side view in partial section of a height adjusting base of the woodworking machining apparatus in FIG. 2;

FIG. 5 is an operational side view in partial section of a holding adjuster of the woodworking machining apparatus in FIG. 2; and

FIGS. 6 and 7 are operational side views in partial section of the height adjusting adjuster of the woodworking machining apparatus in FIG. 2.

### DETAILED DESCRIPTION OF PREFERRED EMBODIMENT

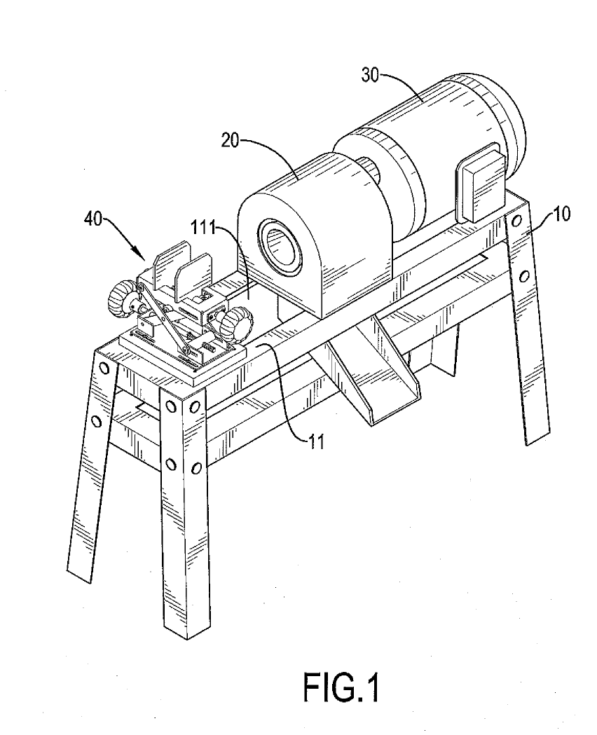

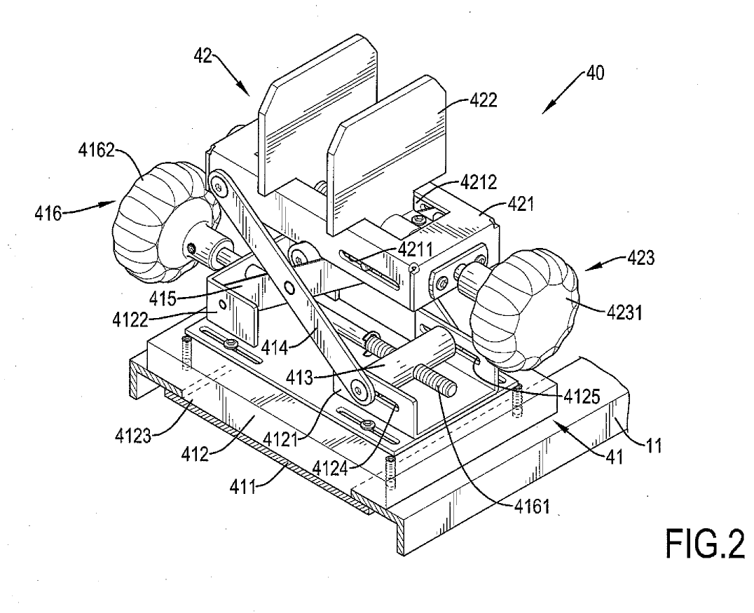

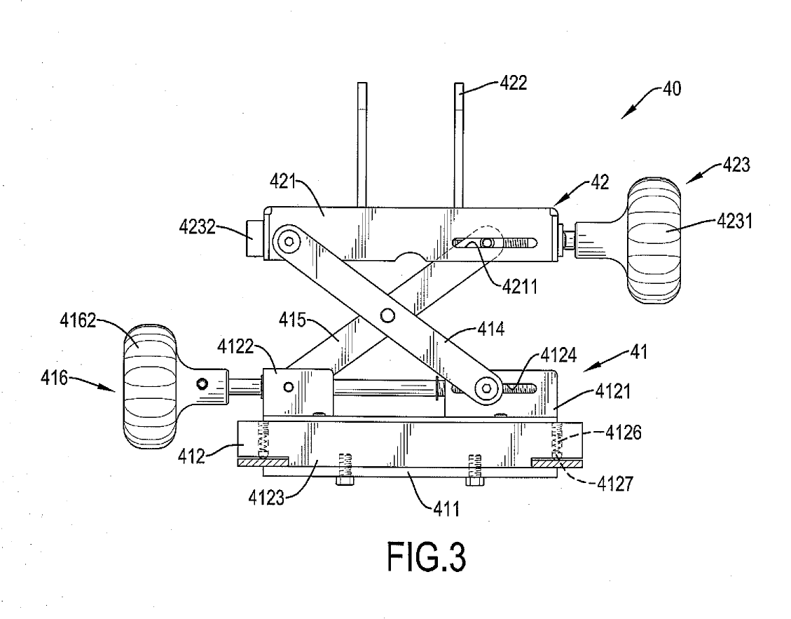

With reference to FIGS. 1 to 4, a woodworking machining apparatus in accordance with the present invention comprises a bed 10, a machining assembly 20, a driving mechanism 30 and a clamping mechanism 40.

The bed 10 has a bed-top 11 disposed on a top of the bed 10. The bed-top 11 has a ditch 111 defined through the bed-top 11. The machining assembly 20 is mounted over the ditch 111 in the bed-top 11. The driving mechanism 30 is mounted on the bed 10 for driving the machining assembly 20.

The clamping mechanism 40 is mounted over the ditch 111 in the bed-top 11. The clamping mechanism 40 is movable along the ditch 111 and relative to the machining assembly 20. The clamping mechanism 40 includes a height adjuster 41 and a holding adjuster 42.

The height adjuster 41 includes a stabilizing board 411, a height adjusting base 412, a sliding rod 413, a first connecting rod 414, a second connecting rod 415 and a height adjusting lever 416.

The stabilizing board 411 has a width greater than that of the ditch 111. The height adjusting base 412 is fixed on a top of the stabilizing board 411 with screws. The height adjusting base 412 is rectangular. Two ends of the height adjusting base 412 are respectively located on two sides of the ditch 111. The height adjusting base 412 has a first seat 4121, a second seat 4122, a protrusion 4123, four supporting holes and four supporters.

The first seat 4121 and the second seat 4122 are disposed on a top of the height adjusting base 412 and faced to each other. The first seat 4121 has a first slot 4124 and a first auxiliary slot 4125 respectively defined through two sides of the first seat 4121. The first slot 4124 and the first auxiliary slot 4125 are positioned in parallel and extend parallelly to the length of the height adjusting base 412.

The protrusion 4123 extends downwardly from a middle of a bottom of the height adjusting base 412 and extends toward two sides of the height adjusting base 412. The protrusion 4123 has a width being substantially equal to that of the ditch 111 such that the protrusion 4123 is correspondingly received in the ditch 111. The four supporting holes are defined through the height adjusting base 412 and respectively located on two sides of the protrusion 4123 for respectively receiving the four supporters. Each supporter is protruded from the bottom of the height adjusting base 412 for lifting the height adjusting base 412 from the bed-top 11. Each supporter includes a sunk screw, an elastomer 4126 and a ball 4127. The sunk screw is screwed into a corresponding supporting hole and located adjacent to the top of the height adjusting base 412. The elastomer 4126 is mounted in the corresponding supporting hole and has two ends. One end of the ends of the elastomer 4126 abuts against the sunk screw and the other end of the elastomer 4126 abuts against the ball 4127. The ball 4127 is partially protruded from the corresponding supporting hole.

The sliding rod 413 is mounted in the first seat 4121 and has two ends respectively movably mounted in the first slot 4124 and the first auxiliary slot 4125. The first connecting rod 414 has a first end and a second end opposite to the first end. The first end of the first connecting rod 414 is pivotally connected to the sliding rod 413 and is movable along the first slot 4124. The second connecting rod 415 has a first end, a second end being opposite to the first end and a middle part located between the first end and the second end. The first end of the second connecting rod 415 is pivotally connected to the second seat 4122. The middle part of the second connecting rod 415 is pivotally connected to a middle part of the first connecting rod 414 such that the second connecting rod 415 and the first connecting rod 414 are pivotally connected to each other. The height adjusting lever 416 is rotatably mounted on the height adjusting base 412. The height adjusting lever 416 has a threaded portion 4161 disposed on one end of the height adjusting lever 416, a handle 4162 disposed on the other end of the height adjusting lever 416 and a buckling ring fixed on the height adjusting lever 416 and located between the threaded portion 4161 and handle 4162 to prevent the height adjusting lever 416 from detaching from the height adjusting base 412. The threaded portion 4161 of the height adjusting lever 416 is screwed through the sliding rod 413 for screwedly driving the sliding rod 413 to move relative to the height adjusting lever 416.

The holding adjuster 42 is movably mounted on the height adjuster 41. The holding adjuster 42 includes a holding base 421, two clamping sheets 422 and a holding lever 423. The holding base 421 is rectangular and is stacked on the height adjusting base 412. The holding base 421 has a second slot 4211 defined in one side of the holding base 421 and an adjusting groove 4212 defined in a top of the holding base 421. The second end of the first connecting rod 414 is pivotally connected to the holding base 421. The second end of the second connecting rod 415 is pivotally mounted in the second slot 4211 and is movable along the second slot 4211.

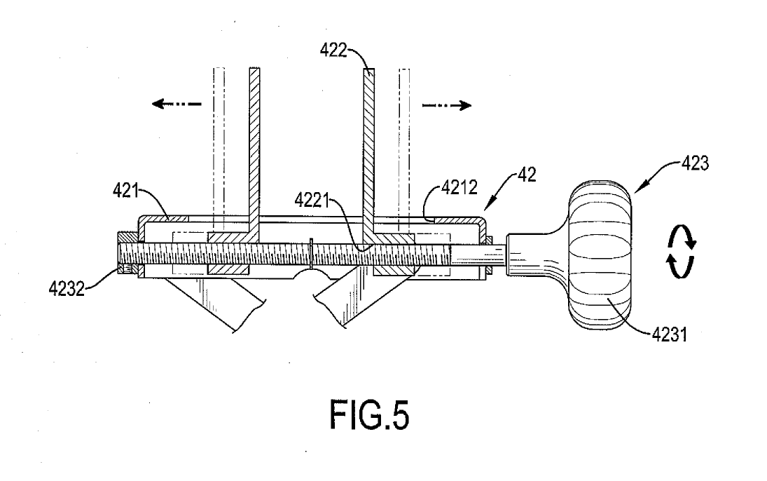

With further reference to FIG. 5, the two clamping sheets 422 are partially received in the adjusting groove 4212 in parallel for holding a workpiece. Each clamping sheet 422 has a screw hole 4221 defined through the clamping sheet 422. A thread in the screw hole 4221 of one of the clamping sheets 422 is opposite to that of the other clamping sheet 422 in thread direction.

The holding lever 423 is rotatably mounted through the holding base 421 and has a threaded portion formed on the holing lever 423 and screwed through the two screw holes 4221 of the two clamping sheets 422 for driving the two clamping sheets 422 to move relative to each other. The holding lever 423 has a handle 4231 disposed on one end of the holding lever 423 and a fixing ring 4232 fixed on the other end of the holding lever 423 to prevent the holding lever 423 from detaching from the holding base 421.

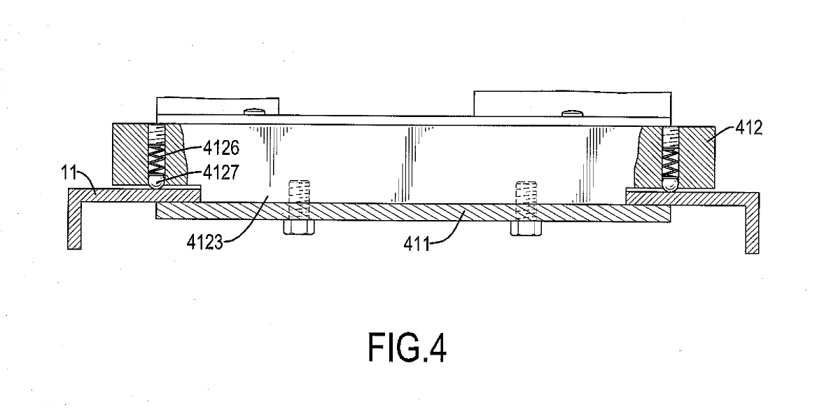

With reference to FIG. 4, the protrusion 4123 is slidably received in the ditch 111. The balls 4127 of the supporters cooperate the elastomers 4126 to elastically lift the height adjusting base 412 from the bed-top 11 for decreasing a contact between the height adjusting base 412 and the bed-top 11 and increasing a smooth of the height adjusting base 412 moving along the ditch 111. The stabilizing board 411 is fixed on the bottom of the protrusion 4123 of the height adjusting base 412 and has a width greater than that of the ditch 111, such that the bed-top 11 is squeezed between the balls of the supporters of the height adjusting base and the stabilizing board 411 to prevent the height adjusting base 412 from detaching from the ditch 111.

With reference to FIG. 5, the threaded portion of the holding lever 423 simultaneously engages the two threads of the two screw holes 4221 of the two clamping sheets 422. When the holding lever 423 is rotated, the fixing ring 4232 keeps the holding lever 423 rotating in a same position without moving relative to the holding base 421. The two screw holes 4221 of the two clamping sheets 422 have the same pitches. The two clamping sheets 422 are driven by the holding lever 423 and are moved toward or away from each other at a same speed. An axis of the workpiece, especially a wood bar, can be kept in a middle of the holding base 421.

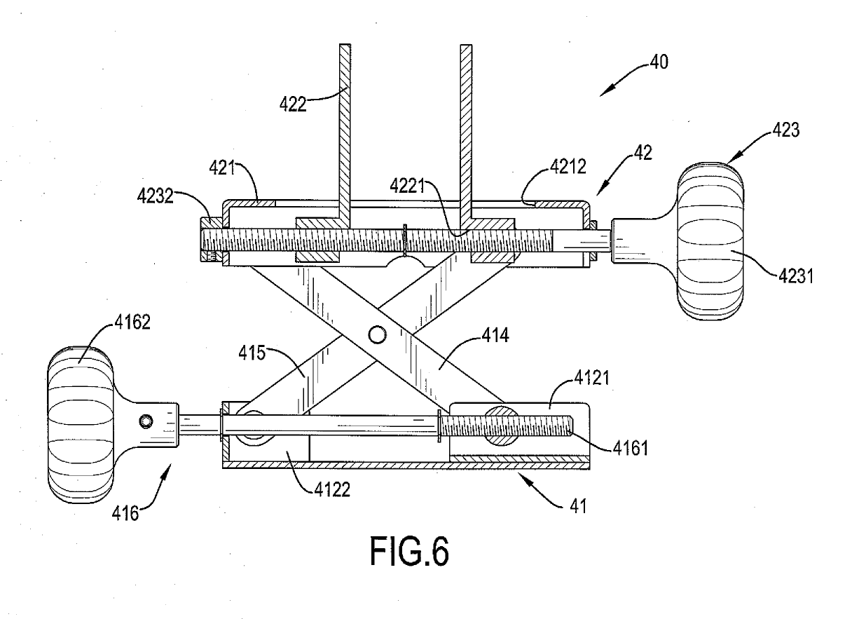

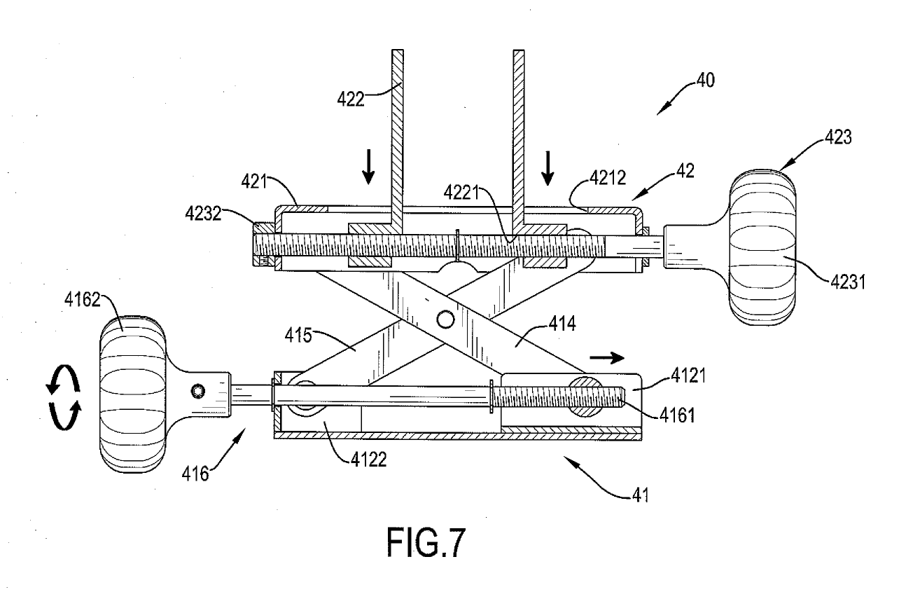

With reference to FIGS. 6 and 7, the height adjusting lever 416 engages the sliding rod 413 for driving the sliding rod 413 to move relative to the height adjusting lever 416. The sliding rod 413 is pivotally connected to the first connecting rod 414 and the first connecting rod 414 is pivotally connected to the second connecting rod 415, such that the sliding rod 413 drives the first connecting rod 414 relatively driving the second connecting rod 415 for lifting the holding base 421 up and down. The second end of the second connecting rod 415 is slid along the second slot 4211. A moving distance of the second end of the second connecting rod 415 in the second slot 4211 is equal to that of the sliding rod 413 in the first slot 4124, such that the holding base 421 is kept in parallel to the height adjusting base 412. A height of the holding base 421 is changed by the height adjuster 41. A horizontal distance of the holding base 421 relative to the height adjusting base 412 is not changed. Therefore, the axis of workpiece is kept in the middle of the holding base 421 and a height of the workpiece is adjustable, such that the workpiece can be precisely aligned to the machining assembly 20.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A woodworking machining apparatus comprising:
a bed having a bed-top disposed on a top of the bed, the bed-top having a ditch defined through the bed-top;
a machining assembly mounted over the ditch in the bed-top;
a driving mechanism mounted on the bed for driving the machining assembly; and
a clamping mechanism mounted over the ditch in the bed-top, being movable relative to the ditch and having
a height adjuster including
a height adjusting base having a first seat disposed on a top of the height adjusting base, a second seat disposed on the top of the height adjusting base, a protrusion extending from a bottom of the height adjusting base to be correspondingly received in the ditch and at least two supports disposed on the bottom of the height adjusting base and respectively located on two sides of the protrusion for lifting the height adjusting base from the bed-top, the first seat having a first slot defined through the first seat;
a sliding rod mounted in the first seat, having one end mounted in the first slot, and being slidable along the first slot;
a first connecting rod having a first end and a second end being opposite to the first end, the first end of the first connecting rod pivotally connected to the sliding rod, being pivotable relative to the sliding rod and being movable relative to the first seat;
a second connecting rod having a first end, a second end being opposite to the first end and a middle part located between the first end and the second end, the first end of the second connecting rod pivotally connected to the second seat, the middle part of the second connecting rod pivotally connected to a middle part of the first connecting rod such that the second connecting rod and the first connecting rod are pivotally connected to each other;
a height adjusting lever rotatably mounted on the height adjusting base and screwed through the sliding rod for screwedly driving the sliding rod to move relative to the height adjusting lever; and
a stabilizing board fixed on a bottom of the protrusion of the height adjusting base and having a width greater than that of the ditch such that the bed-top is located between the at least two supporters of the height adjusting base and the stabilizing board; and
a holding adjuster movably mounted on the height adjuster and including
a holding base having a second slot defined in one side of the holding base and an adjusting groove defined in a top of the holding base, the second end of the first connecting rod pivotally connected to the holding base, the second end of the second connecting rod pivotally mounted in the second slot and being movable along the second slot;
two clamping sheets partially received in the adjusting groove in parallel, each clamping sheet having a screw hole defined through the clamping sheet, a thread in the screw hole of one of the clamping sheets being opposite to that of the other clamping sheet; and
a holding lever rotatably mounted on the holding base and screwed through the two screw holes of the two clamping sheets for driving the two clamping sheets to move relative to each other.

2. The woodworking machining apparatus as claimed in claim 1, wherein each supporter includes an elastomer mounted in the bottom of the height adjusting base and a ball abutting with the elastomer and protruding from the bottom of the height adjusting base.

3. The woodworking machining apparatus as claimed in claim 2, wherein the holding lever has a handle disposed on one end of the holding lever and a fixing ring fixed on the other end of the holding lever to prevent the holding lever from detaching from the holding base; and
the height adjusting lever has a threaded portion disposed on one end of the height adjusting lever for screwing through the sliding rod, a handle disposed on the other end of the height adjusting lever and a buckling ring fixed on the height adjusting lever and located between the threaded portion and handle to prevent the height adjusting lever from detaching from the height adjusting base.
